(19) United States
(12) Patent Application Publication
(10) Pub. No.: US 2017/0278087 A1
(43) Pub. Date: Sep. 28, 2017

(54) VIRTUAL MACHINE PRICING MODEL

(71) Applicant: Google Inc., (US)

(72) Inventors: Joseph S. Beda, III, Seattle, WA (US); Craig I. McLuckie, Sammamish, WA (US)

(73) Assignee: Google Inc., Mountain View, CA (US)

(21) Appl. No.: 13/798,813

(22) Filed: Mar. 13, 2013

Related U.S. Application Data
(60) Provisional application No. 61/616,760, filed on Mar. 28, 2012.

(51) Int. Cl. G06Q 30/06; G06Q 10/06

(52) U.S. Cl. CPC G06Q 20/145; H04L 43/0876

(57) ABSTRACT

Methods, systems, and apparatus, including computer programs encoded on a computer storage medium, for determining a measure of resource usage by a virtual machine between startup and termination. The determination can be based on units of time in a sequence of contiguous units of time from the startup to the termination of a virtual machine. The actual utilization of a resource by the virtual machine during a unit of time may be compared to a resource utilization cap for the resource for the unit of time. If the utilization cap is exceeded, the excess resource utilization is determined. If the resource utilization cap is not exceeded, a resource utilization shortfall is determined. The measure of resource usage can be based on the number of units of time, the resource utilization cap for each resource, and the amount of excess resource utilization for each resource.

### CROSS-REFERENCE TO RELATED APPLICATIONS

This application claims priority under 35 U.S.C. §119(e)(1), to U.S. Provisional Application Ser. No. 61/616,760, filed on Mar. 28, 2012, the entire contents of which are incorporated herein.

### BACKGROUND

This specification generally relates to providing virtual communication networks.

Cloud computing is network-based computing in which typically large collections of servers, housed in data centers or “server farms”, provide computational resources and data storage as needed to remote end users. Some cloud computing services provide access to software applications such as word processors and other commonly used applications to end users who interface with the applications through web browsers or other client-side software. Users' electronic data files are usually stored in the server farm rather than on the users' computing devices. Maintaining software applications and user data on a server farm simplifies management of end user computing devices. Some cloud computing services allow end users to execute software applications in virtual machines.

### SUMMARY

In general, one innovative aspect of the subject matter described in this specification can be embodied in methods that include the actions of determining a measure of resource usage by a virtual machine between startup and termination, including, for each unit of time in a sequence of contiguous units of time beginning with a startup of a virtual machine and ending with a unit of time within which a termination of the virtual machine occurs, and for each of one or more monitored resources, comparing actual resource utilization of the resource by the virtual machine during the unit of time with a resource utilization cap for the resource for the unit of time, and if the actual resource utilization exceeds the resource utilization cap, determining an excess resource utilization for the resource for the unit of time, and determining the measure of resource usage based on the number of units of time, the resource utilization cap for each resource, and the amount of each excess resource utilization for each resource.

Other embodiments of this aspect include corresponding systems, apparatus, and computer programs, configured to perform the actions of the methods, encoded on computer storage devices.

These and other embodiments can each optionally include one or more of the following features. The actions further include determining a number of contiguous units of time in the sequence of contiguous units of time, determining a resource securing fee, the resource securing fee being a result of multiplying the determined number of contiguous units of time with a fee per unit of time, determining an excess resource utilization fee based on the amount of each excess resource utilization for each resource, and identifying a result of adding the resource securing fee, and the excess resource utilization fee as the fee to be associated with the measure of resource usage. The actions further include where determining the resource securing fee further includes determining the fee per unit of time by accessing a resource usage fee table. The actions further include determining a number of contiguous units of time in the sequence of contiguous units of time, determining a resource securing fee, the resource securing fee being a result of multiplying the determined number of contiguous units of time with a fee per unit of time, determining an excess resource utilization fee based on the amount of each excess resource utilization for each resource, and identifying a result of adding a minimum resource securing fee, the resource securing fee, and the excess resource utilization fee as the fee to be associated with the measure of resource usage. The one or more monitored resources include disk I/O accesses, network utilization, memory usage and network address usage. The actions further include identifying a first detection of a heartbeat as indicative of the startup of the virtual machine, identifying a detection of an absence of the heartbeat as indicative of the termination of the virtual machine, and determining the measure of resource usage by the virtual machine for a time interval defined by the first detection of the heartbeat and the detection of the absence of the heartbeat. If the actual resource utilization is less than the resource utilization cap, the actions further include determining a resource utilization shortfall for the resource for the unit of time, and adding at least a portion of the resource utilization shortfall to a resource utilization cap for the resource for the subsequent unit of time. The portion of the resource utilization shortfall for the resource for the unit of time is less than or equal to a resource utilization shortfall cap.

Particular embodiments of the subject matter described in this specification can be implemented so as to realize one or more of the following advantages. The use of fine grained billing granularity along with a flat fee for a connection can provide a customer with a predictable model for virtual machine resource utilization that can then be further fine-tuned for the customer's needs. Providing individual units of time in a sequence of contiguous units of time for the runtime duration of a virtual machine can allow a customer to pay for and monitor resource utilization at the unit of time level. In addition, a customer can prepay for a fixed number of resources that can be used during a unit of time establishing a resource utilization cap for each unit of time. Excess resource usage in a unit of time (the number of resources used exceeds the cap) can be billed as an overage at a certain rate. Resources paid for but not used in a unit of time (the number of resources used is below the cap) may be rolled over into the next unit of time. A customer may remove “bursts” in resource utilization from their application workload in order to reduce overall usage costs.

In addition, the fine grained billing granularity allows a customer to pay for the resources needed for a set period of time as the time period can be determined as a sum of incremental smaller units of time and the prepaid resource utilization can be determined based on the customer's average workload requirement during each unit of time. This results in a billing model that the customer can more easily understand.

Many of today's customers may manage the scheduling of virtual machine resource utilization around full hour boundaries in order to adequately drive the resource utilization. The need for this type of resource management can contribute to increased cost due to the complexity of the scheduling of workloads. The fine grained billing granularity relaxes this need, allowing the customer to manage the scheduling in finer boundary constraints. The finer boundaries not only allow the reduction of the complexity of the scheduling of the workloads but also allow for the fine grained billing granularity.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example system that can execute implementations of the present disclosure.

FIG. 2 is a block diagram of an example system that can measure resource usage by a virtual machine.

FIG. 3 is a flow diagram illustrating an example process for determining a measure of resource usage by a virtual machine.

FIG. 4 is a schematic diagram of an example host machine.

Like reference numbers and designations in the various drawings indicate like elements.

### DETAILED DESCRIPTION

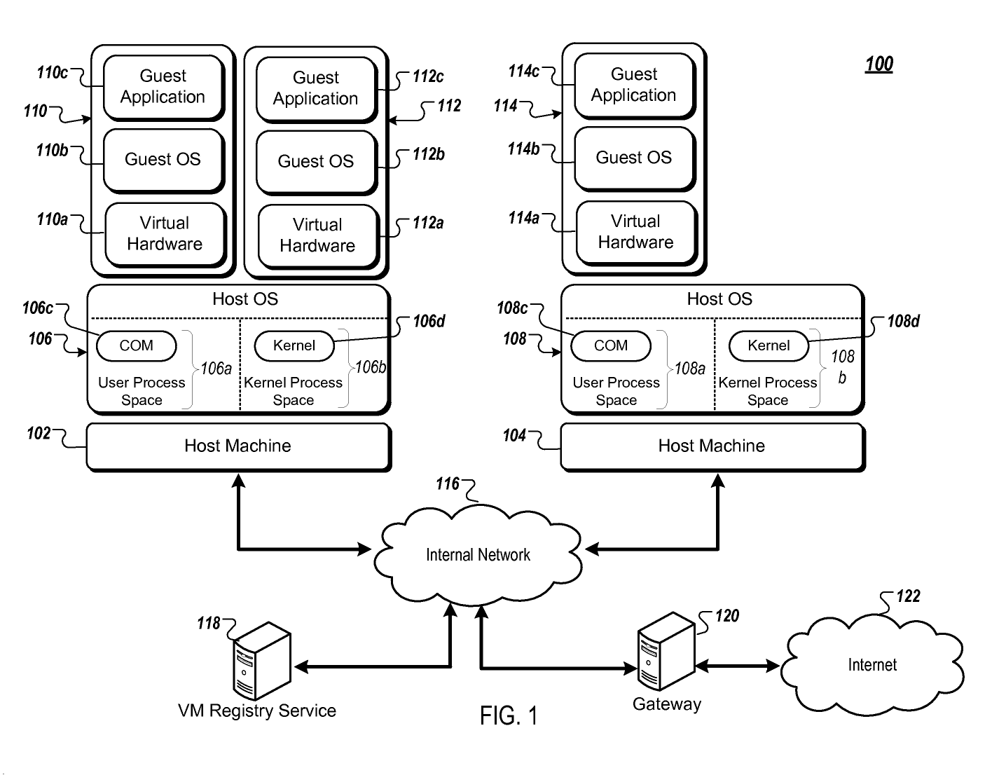

FIG. 1 is a diagram of an example virtual machine system 100 that can execute implementations of the present disclosure. Referring to FIG. 1, for example, the system 100 includes one or more host machines (e.g., host machine 102 and host machine 104). In general, a host machine can be one or more data processing apparatus such as rack mounted servers or other computing devices. The data processing apparatus can be in different physical locations and can have different capabilities and computer architectures. The host machines 102, 104 can communicate with each other through an internal data communications network 116. For example, the internal network 116 can include one or more wired (e.g., Ethernet) or wireless (e.g., WI-FI) networks. In some implementations, the internal network 116 is an intranet. The host machines 102, 104 can also communicate with devices on external networks, such as Internet 122, through one or more gateways (e.g., gateway 120). The gateway 120 is data processing apparatus responsible for routing data communication traffic between the internal network 116 and the Internet 122. In addition, other types of external networks are possible.

Each host machine 102, 104 can execute a host operating system or other software that virtualizes the underlying host machine hardware and manages concurrent execution of one or more virtual machines. For example, the host operating system 106 is managing virtual machine (VM) 110 and VM 112, while host operating system 108 is managing a single VM 114. Each VM includes a simulated version of the underlying host machine hardware, or a different computer architecture. The simulated version of the hardware is referred to as virtual hardware (e.g., virtual hardware 110a , 112a and 114a ). Software that is executed by the virtual hardware is referred to as guest software. In some implementations, guest software cannot determine if it is being executed by virtual hardware or by a physical host machine. If guest software executing in a VM, or the VM itself, malfunctions or aborts, other VMs executing on the host machine will not be affected. A host machine's one or more processors can include processor-level mechanisms to enable virtual hardware to execute software applications efficiently by allowing guest software instructions to be executed directly on the host machine's processor without requiring code-rewriting, recompilation, or instruction emulation.

Each VM (e.g., VMs 110, 112 and 114) is allocated a set of virtual memory pages from the virtual memory of the underlying host operating system. In addition, each VM (e.g., VMs 110, 112 and 114) is allocated virtual disk blocks from one or more virtual disk drives for use by the guest software executing on the VM. For example, host operating system 106 allocates memory pages and disk blocks to VM 110 and VM 112, and host operating system 108 allocates memory pages and disk blocks to VM 114. In some implementations, a given VM may not access the virtual memory pages assigned to other VMs. For example, VM 110 cannot access memory pages that have been assigned to VM 112. A virtual disk drive can be persisted across VM restarts. For example, virtual disk blocks are allocated on physical disk drives coupled to host machines or available over the internal network 116.

In addition to virtual memory and disk resources, VMs can be allocated network addresses through which their respective guest software can communicate with other processes reachable through the internal network 116 or the Internet 122. For example, guest software executing on VM 110 can communicate with guest software executing on VM 112 or VM 114. In some implementations, each VM is allocated one or more unique Internet Protocol (IP) addresses and one or more User Datagram Protocol (UDP) port numbers. In addition, other address schemes are possible.

A VM's guest software can include a guest operating system (e.g., guest operating systems 110b , 112b and 114b ) which is software that controls the execution of respective guest software applications (e.g., guest applications 110c , 112c and 114c ) within the VM. In addition, the guest operating system provides services to the guest applications. For example, a guest operating system could be a variation of the UNIX operating system. Each VM can execute the same guest operating system or each VM can execute a different guest operating systems. In further implementations, a VM may not require a guest operating system in order to execute guest software applications. A guest operating system's access to resources such as networks and virtual disk storage can be controlled by the underlying host operating system.

By way of illustration, and with reference to virtual machine 110, when the guest application 110c or guest operating system 110b attempts to perform an input/output operation on a virtual disk, initiate network communication, or perform a privileged operation, for example, the virtual hardware 110a is interrupted so that the host operating system 106 can perform the action on behalf of the virtual machine 110. The host operating system 106 can perform these actions with a process that executes in kernel process space 106b , user process space 106a , or both.

The kernel process space 106b is virtual memory reserved for the host operating system 106's kernel 106d which can include kernel extensions and device drivers, for instance. The kernel process space has elevated privileges (sometimes referred to as “supervisor mode” privileges); that is, the kernel 106d can perform certain privileged operations that are off limits to processes running in the user process space 106a . Examples of privileged operations include, but are not limited to, access to different address spaces, and access to special functional processor units in the host machine such as memory management units. The user process space 106a can be a separate portion of virtual memory reserved for user mode processes. User mode processes cannot directly perform privileged operations.

In various implementations, a portion of VM network communication functionality is implemented in a communication process (e.g., communication process 106c ). In some implementations, the communication process executes in the user process space (e.g., user process space 106a ) of a host operating system (e.g., host operating system 106). In other implementations, the communication process can execute in the kernel process space (e.g., kernel process space 106d ) of the host operating system. There can be a single communication process for all VMs executing on a host machine or multiple communication processes, one for each VM executing on a host machine.

In yet further implementations, some portion of the communication process executes in the user process space and another portion executes in the kernel process space. The communication process communicates with a directory service (e.g., VM registry service 118) in order to establish a virtual network pair (VNP) between two VMs. A virtual network pair (VNP) is a logical computer network that is implemented on top of one or more physical (wired or wireless) computer networks. A VNP routes traffic between two endpoints using one or more virtual connections or links. By way of illustration, a VNP between virtual machine 110 and virtual machine 114 would route packets sent between VNP endpoints managed respectively by communication processes 106c and 108c over internal network 116. The VM registry service 118 is one or more data processing apparatus that execute software for keeping track of assignments of network addresses (e.g., IP addresses) to VMs, and for keeping track of network addresses (e.g., IP addresses) of host machines that the VMs are executing on. The data processing apparatus can be in different locations and can have different capabilities and computer architectures.

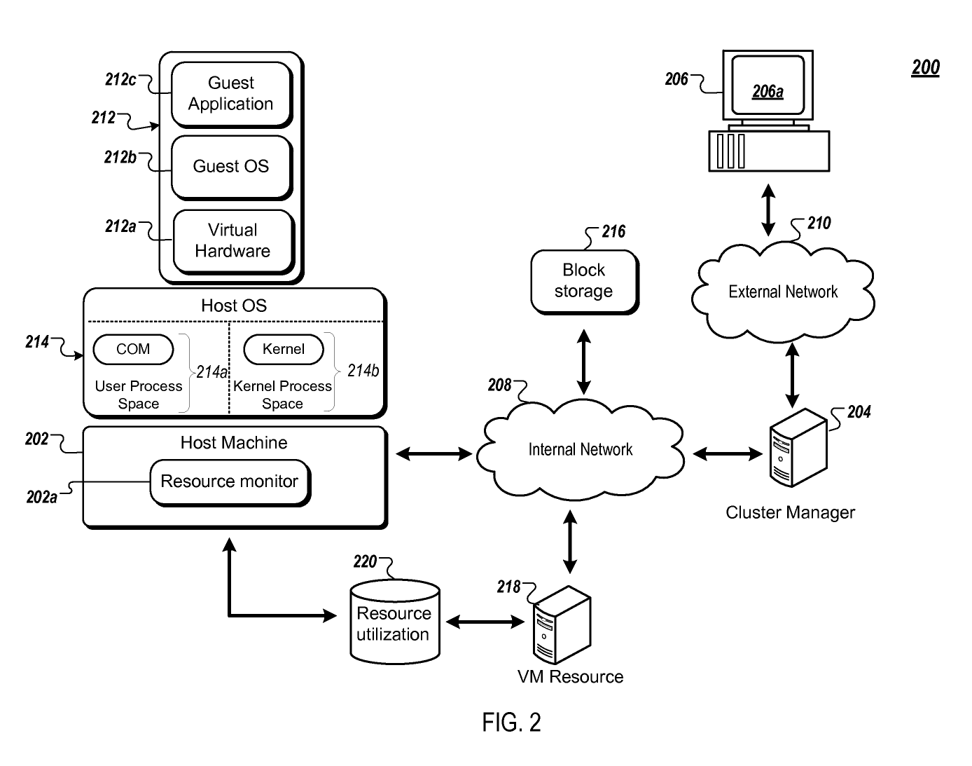

FIG. 2 is a block diagram of an example system 200 that measures resource usage by a VM. Referring to FIG. 2, the system 200 includes a host machine 202 that communicates through a cluster manager 204 with a computing device 206 by way of an internal data communications network 208. The computing device 206 communicates with the cluster manager 204 by way of an external network 210, for example, the Internet.

In some implementations, the cluster manager 204 provides an application programming interface (API) to a software application running on the computing device 206. The API allows a user to communicate with the cluster manager 204 in order to request the start of a VM, for example, by identifying the data to be used by the VM and application code to be executed by the VM. In some implementations, the user initiates the start of a VM using the interface. In some implementations, the user sets up a regularly scheduled (e.g., daily, weekly, or monthly) request to start a VM. In another example, the user accesses a web site that provides an interface that allows the user to manage and request the start of a VM.

In some implementations, a virtual network is implemented as an encapsulated network on the internal network 208. A gateway can connect the virtual network to the internal network. In addition, the gateway can allow the computing device 206 to communicate with a VM on the virtual network by routing data communication traffic between the internal network 208 and the external network 210.

In the example of FIG. 2, the computing device 206 provides the request to start a VM to the cluster manager 204 by way of the external network 210. The cluster manager 204 then proceeds to schedule and start a VM on the host machine 202. The host machine 202 executes a host operating system 214 or other software that virtualizes the underlying host machine hardware, starting VM 212, and that manages concurrent execution of the VM 212 that provides the requesting user with a “logical container” in which to run their application code.

The VM 212 includes a simulated version of the hardware of the host machine 202 (e.g., virtual hardware 212a ). The virtual hardware 212a can execute guest software such as a guest operating system (OS) 212b that controls the execution of a guest software application 212c within the VM 212. In addition, the guest OS 212b can provide services to the guest application 212c . One or more processors included in the host machine 202 can provide processor-level mechanisms that enable the virtual hardware 212a to execute the guest software application 212c in the guest OS 212b efficiently by allowing guest software instructions to be executed directly on one or more of processors included in the host machine 202 without requiring code-rewriting, recompilation, or instruction emulation.

The VM 212 is allocated a set of virtual memory pages from the virtual memory of the underlying host operating system 214. The VM 212 is also allocated virtual disk blocks from one or more virtual disk drives for use by the guest software (guest OS 212b and guest applications 212c ) executing on the VM 212. For example, the virtual disk blocks are allocated on physical disk drives available over the internal network 208 (e.g., block storage 216). In some implementations, the physical disk drives can be coupled to the host machine 202. In some implementations, the block storage 216 is persistent block storage and is a form of durable (non-volatile) storage.

In some implementations, the VM 212 may be allocated a network address through which its guest software can communicate with other processes reachable through the internal network 208 or the external network 210. For example, the VM 212 can communicate on a virtual network that is implemented as an encapsulated network on the internal network 208. The virtual network can be implemented by allocating a unique Internet Protocol (IP) address and a User Datagram Protocol (UDP) port on the host machine 202.

In the course of executing the user's application code, the guest software application 212c or the guest operating system 212b can perform input/output (I/O) operations on a virtual disk which can result in one or more physical disk I/O operations. In addition, the guest software application 212c or the guest operating system 212b can initiate network communication on the internal network 208. For example, the guest software application 212c or the guest operating system 212b may use an internal network access when performing I/O operations in order to access the block storage 216. In another example, the guest software application 212c or the guest operating system 212b may access both the internal network 208 and the external network 210 when communicating with the computing device 206. In this example, the guest software application 212c or the guest operating system 212b may provide information to the user of the computing device 206.

The guest software application 212c or the guest operating system 212b can perform a privileged operation. For example, the virtual hardware 212a is interrupted so that the host operating system 214 can perform an operation on behalf of the virtual machine 212. The host operating system 214 can perform the operation using a process that executes in a kernel process space 214b , a user process space 214a , or both. Referring to FIG. 1, the kernel process space 214b and the user process space 214a perform in a similar manner to the kernel process space 106b and the user process space 106a , respectively.

In the example of FIG. 2, the host machine 202 includes a resource monitor 202a for monitoring resource usage by the VM 212 between the startup (creation) of the VM 212 and the termination (destruction) of the VM 212. Resource usage can include, but is not limited to, disk I/O accesses, network accesses, amount of storage memory used, and the number of reserved addresses needed by the host machine 202. In some implementations, the resource monitor 202a is included in the system 200 but separate from the host machine 202. For example, an additional machine in the system 200 may include the resource monitor 202a.

In some implementations, the cluster manager 204 receives an API call from the computing device 206 by way of the external network 210 that the computing device 206 would like to create a VM. The cluster manager 204 can provide a signal to the host machine 202 by way of internal network 208 that starts up the VM 212. The host machine 202 can provide a signal back to the cluster manager 204 by way of internal network 208 when the VM 212 is terminated. The cluster manager 204 can provide an indication to the computing device 206 by way of external network that the VM 212 has been terminated.

In some implementations, a persistent log record is generated on a regular interval basis (e.g., generated every minute) once the VM is created. The persistent log record can be referred to as a “heartbeat”. The generation of the heartbeat continues at the regular interval for the duration of the running of the VM. When the VM is terminated, the heartbeat is no longer generated. The determination of the running of the VM can be based on the detection of the existence of the heartbeat. For example, when the VM is created, the generation of the heartbeat begins. The regular interval of the heartbeat can be one minute (e.g., generated every minute). The detection of the heartbeat can be indicative of the startup of the VM. The termination of the VM can be determined if the heartbeat is no longer detected (e.g., two minutes transpire and the heartbeat is not detected).

In some implementations, the resource monitor 202a generates runtime duration data, for example, a pair of time stamp values representative of start and termination times of the VM 212. In some implementations, the resource monitor 202a monitors resource usage on a time basis and generates resource usage data for each monitored resource. Such resource usage data may include, for example, an identifier of the monitored resource, information characterizing a duration (e.g., in the form of a pair of time stamp values) and an amount of the resource usage at varying levels of time-based granularity.

In some implementations of the system 200, the resource monitor 202a can monitor resource usage for multiple virtual machines at a system level. In such cases, the resource monitor 202a generates resource usage data and runtime duration data, as appropriate. The host machine 202 can provide the resource usage data and the runtime duration data to a resource utilization database 220 for persistent storage. In some implementations, the VM resource computing device 218 can analyze the stored data for billing and usage analysis purposes. In other implementations, an additional computing device may perform the analysis of the resource usage data and the runtime duration data stored in the resource utilization database 220.

Resource data may be stored in the resource utilization database 220 in association with an identifier of the user that requested the running of the VM (e.g., the user of computing device 206). In some implementations, the VM resource computing device 218 can be implemented to use conventional report generation techniques to retrieve resource data from the resource utilization database 220, generate resource usage reports on a per-project basis, and store the generated reports in the resource utilization database 220 for subsequent retrieval by (or provision to) the respective users. For example, a project is an abstract account that multiple users have permissions to interact with. In other implementations, as described above, the additional computing device that performs the analysis of the data may also be implemented to generate the resource usage reports.

The VM resource computing device 218 may be implemented to generate a resource usage report that provides a measure of the monitored resource's usage for each unit of time in a sequence of contiguous units of time beginning with a startup of the VM and ending with a unit of time within which a termination of the VM occurs. For example, the resource usage report can include the number of disk I/O accesses by the VM for each 5-minute unit of time during a sequence of contiguous units of time spanning a VM runtime duration of 60 minutes.

In some implementations, a provider of the system 200 stores information characterizing resource utilization caps (or maximum values), and a resource usage fee table(s) in the resource utilization database 220. An example resource usage fee table may specify that a user of the system 200 will be charged a base resource usage fee (e.g., 0.02 cents) for a capped number of resources used (e.g., 50 or less disk I/O accesses per second for each virtual machine) for each 5-minute unit of time. The example resource usage fee table may optionally specify that a user of the system 200 will be charged a fixed startup fee (e.g., $0.02) for each VM spin up. In some cases, the startup fee may vary based on the time of day (e.g., a lower startup fee is applied from 11:00 pm Eastern to 6:00 am Eastern as compared to other times of the day) or the day of the week (e.g., a lower startup fee is applied on weekends). In some cases, a user may be allotted one or more units of time for “free” after paying the startup fee so long as the general resource cap is not exceeded for each unit of time. For example, after paying the fixed startup fee, the user may be given the first four, 5-minute units of time in a sequence of contiguous units of time of the runtime of the VM at no additional cost as long as the resource usage by the VM does not exceed the general resource cap for the resource within the unit of time (e.g., 5000 disk I/O accesses are not exceeded in a 5-minute unit of time).

Another example usage fee table may specify that a user of the system 200 will not be charged for up to a certain number of network accesses (e.g., 100 Mbytes of data transferred for each virtual machine) in a 10-minute unit of time after paying a fixed startup fee. In another example of a usage fee table, the provider of system 200 may specify that a user of the system 200 will be charged resource usage fees in 5-minute units of time for a 30-minute sequence of contiguous units of time even if the VM 212 terminates before the end of the 30 minutes. As such, the user is billed for at least a predetermined minimum amount of runtime for the VM.

In some implementations, a resource usage fee table may include a prestart time parameter specifying that a user of the system 200 will be charged on a unit of time basis after the VM has been running a predetermined amount of time from startup (e.g., 15 minutes). The user may be charged a fixed fee not based on resource utilization by the VM during the prestart time. The VM resource computing device 218 may be implemented to use the information characterizing resource utilization caps, and the resource usage fee table(s) along with the resource data to determine usage fees for a user of the system 200, and provide the resource data and the usage fees to the user of the system 200 in a report. For example, the VM resource computing device 218 can provide the report to the computing device 206 by way of the internal network 208, the cluster manager 204 and the external network 210. For example, the user of the computing device 206 can view the report on a display 206a of the computing device 206.

The resource monitor 202a can record each resource used by the VM 212 by recording an identifier for the monitored resource along with information characterizing when the resource was used (e.g., in the form of a time stamp). The VM resource computing device 218 can be implemented to identify by resource type (e.g., disk I/O access, network access) the number of times the particular resource was used during a particular unit of time. For example, the system 200 can determine that the VM 212 was started at 1:00 pm on Friday Jan. 27, 2012 as a result of a request by the computing device 206 to spin up a VM. The VM resource computing device 218 can determine that the VM 212 performed 4800 disk I/O accesses during the first five minutes of the runtime of the VM 212 from 1:00 pm to 1:05 pm. The VM resource computing device 218 can be implemented to access a resource usage fee table included in the resource utilization database 220 that specifies, for the user of the system 200, a general resource cap (5000) for disk I/O accesses in a 5-minute unit of time. The VM resource computing device 218 can determine that the VM 212 did not exceed the general resource cap for the number of disk I/O accesses in the first 5-minute unit of time.

In some cases, the resource monitor 202a can aggregate resource usage, recording information into a persistent resource log at a predetermined time interval (e.g., once every minute). For example, an entry into the resource log can be the amount of disk I/O accesses, and the network activity that occurred since the last log entry. In some implementations, the VM resource computing device 218 can perform further resource log data aggregation.

The VM resource computing device 218 can continue to identify the number of disk I/O accesses for each 5-minute unit of time in the sequence of contiguous units of time for the duration of the runtime of the VM 212. Continuing with the example above, the VM resource computing device 218 can determine that 5200 disk I/O accesses were performed by the VM 212 during the second five minutes of the runtime of the VM 212 from 1:05 pm to 1:10 pm. Since the VM resource computing device 218 determined that, for the user of the system 200, the general resource cap for disk I/O accesses in a 5-minute unit of time is 15,000, the VM resource computing device 218 can then determine that the VM 212 exceeded the resource cap for the number of disk I/O accesses in the second 5-minute unit of time.

The VM resource computing device 218 can be implemented to compute a cost to the user of the system 200 for utilized resources that exceed the number of utilized resources characterized by the general resource cap for each resource type. Continuing with the example above, the VM resource computing device 218 can determine that the VM 212 performed 200 disk I/O accesses in addition to the 15,000 disk I/O accesses characterized by the general resource cap for disk I/O accesses during the second five minutes of the runtime of the VM 212. In some cases, the user can be charged a fee for each utilized resource that exceeds the number of resources characterized by the general resource cap for the particular resource (e.g., 0.1 cents per disk I/O access over the base 15,000 disk I/O accesses for a total of $0.20). In some cases, the excess utilized resources can be charged to the user on a block by block basis. For example, the user can be charged a cost per block of excess resources used (e.g., 0.10 cents for each block of 5000 disk I/O access over 15,000, which in this example would be one block for a total of 0.10 cents).

In some implementations, the fees charged for the utilized resources that exceed the number of utilized resources characterized by the general resource cap for the particular resource are accrued on an increasing basis dependent on the number of excess utilized resources. In the case where a user of the system 200 is charged a fee for each utilized resource over the number of utilized resources characterized by general resource cap for the particular resource, the user may be charged a first cost per excess utilized resource up to a first number of excess utilized resources and a second cost per excess utilized resource above the first number of excess utilized resources (e.g., 0.10 cents for each block of 5000 disk I/O accesses over the base 15,000 accesses for the first 30,000 disk I/O accesses and 0.20 cents for each block of 5000 disk I/O access above the 30,000 extra disk I/O accesses). In the case where the user is charged a fee for excess utilized resources on a block basis, the fee charged to the user per block may increase as the number of blocks increases (e.g., 0.075 cents for the first block of 15,000 excess disk I/O accesses, 0.15 cents for the second block of 15,000 excess disk I/O accesses, and so on).

In some implementations, a hard resource cap, stored in the resource utilization database 220, characterizes a maximum number of utilized resources not to be exceeded by the VM during the particular unit of time for the particular resource (e.g., 20,000 disk I/O accesses in a 5-minute unit of time). For example, the number of utilized resources characterized by the hard resource cap can be determined based on the desired performance of the system 200. If the number of utilized resources characterized by the hard resource cap is exceeded, the performance of the system 200 may be less than optimal, resulting in unacceptable computing throughput. If the use of the resources by the VM 212 during a particular period of time exceeds the number of utilized resources characterized by the hard resource cap for the particular resource, the user may be given a warning or some other indication of the occurrence in the resource usage report (e.g., the resource usage report highlights and flags the number of excess resources used for the particular period of time).

Referring back to the example above, the VM resource computing device 218 determined that the resources used by the VM 212 in the first 5-minute unit of time did not exceed the number of utilized resources characterized by the general resource cap for the number of disk I/O accesses for a 5-minute unit of time. In some cases, the number of base resource utilizations paid for by the user of the system 200 but not used during the particular period of time may no longer be credited to the user (e.g., the 200 disk I/O accesses of the 5000 disk I/O accesses not used in the first five minutes of the runtime of the VM 212 are lost). In some cases, these unused resources can be “rolled over” to the next unit of time in the sequence of contiguous time units. Continuing with the example above, the number of utilized resources characterized by the general resource cap for the second five minutes of the runtime of the VM 212 can be increased by the rollover amount from the first five minutes of the runtime of the VM 212 (e.g., the general resource cap for disk I/O accesses during the second five minutes of the runtime of the VM 212 is 5000+200=5200 disk I/O accesses). The system 200 may determine that 5200 disk I/O accesses were performed during the second five minutes of the runtime of the VM 212 from 1:05 pm to 1:10 pm. In this example, the user would not incur any excess fees for resources used during the second five minutes of the runtime of the VM 212 as the number of utilized resources characterized by the general resource cap was increased for this time period to include the unused resources from the previous time period.

In some implementations, as described above, the unused resources for a particular unit of time (the number characterizing the general resource cap less the number of resources used) can rollover from the particular unit of time to the next unit of time in the sequence of contiguous units of time. In some implementations, the provider of system 200 allows a single rollover to occur during the runtime of a VM. In other implementations, the provider of system 200 caps (or limits) the number of unused resources that can rollover from a particular unit of time to the next unit of time in the sequence of contiguous units of time. A fixed amount of resource usage (e.g., 1000 disk I/O accesses) or a percentage of the general resource cap (e.g., 10% of the 5000 disk I/O accesses) can characterize a rollover resource cap. For example, the number of unused resources that may be rolled over from a particular unit of time to the next unit of time can be capped at 10% of the number that characterizes a general resource cap (e.g., 10% of 5000 disk I/O accesses results in 500 disk I/O accesses for a rollover resource cap of 500).

In some implementations, an allowable resource cap, stored in the resource utilization database 220, is an additional cap that may be placed on the number of unused resources that may be rolled over from a particular unit of time to the next unit of time in the sequence of contiguous units of time. For example, the number of utilized resources characterized by the allowable resource cap for a 5-minute unit of time can be 9999 and the number of utilized resources characterized by the general resource cap for the same 5-minute unit of time can be 5000. Therefore, no more than 4999 resources can be rolled over from one 5-minute unit of time to the next 5-minute unit of time in the sequence of contiguous units of time. In another example, the number of utilized resources characterized by the allowable resource cap for a 5-minute unit of time can be 15,000 and the number of utilized resources characterized by the general resource cap for the same 5-minute unit of time can be a percentage (e.g., 66 percent). Therefore, if the consumer utilized 5000 resources in the 5-minute unit of time, though 10,000 resources remain unused in the 5-minute unit of time, only 66 percent of the unused resources (e.g., 6600) can be rolled over from one 5-minute unit of time to the next 5-minute unit of time in the sequence of contiguous units of time.

The VM resource computing device 218 can be implemented to calculate a resource securing fee for the runtime of the VM. The resource securing fee is the total of each of the base resource usage fees for each of the time units that comprise the runtime of the VM. For example, the resource securing fee for disk I/O accesses (e.g., 0.50 cents for the runtime of the VM 212 can be determined by adding together the base resource usage fees (e.g., three cents) for each of five contiguous 5-minute units of time where the runtime of the VM is 25 minutes. In addition, any excess resource utilization fees (fees for resources used above the number of utilized resources characterized by the general resource cap for each unit of time and not rolled over to the next unit of time) can be added to the resource securing fee. A minimum resource securing fee can additionally be added to the resource securing fee. As described above, a minimum resource securing fee can be a fixed startup cost or a fixed fee charged during a prestart time of the VM where the prestart time can be an amount of time (e.g., 15 minutes) before the user is billed on a unit of time basis.

In general, resource usage by a VM can be dependent on a number of factors. In addition, in some cases, multiple VMs may be used to run a user's application. The determination of the use of a single or multiple VMs can be based on a specific throughput time requested by the user (e.g., the user requests the results in a set time frame (e.g., within one hour, within one day, etc.)). In order to maintain the requested throughput time without exceeding the number of utilized resources characterized by the hard resource cap or the number of utilized resources characterized by the general resource cap for a unit of time, the system 200 can be implemented to use multiple VMs. In this case, the runtime for each VM can be monitored and billed as described.

The VM resource computing device 218 can be implemented to generate and provide a user with a resource usage report. In some implementations, the resource usage report includes the resource data associated with the running of a VM (e.g., VM 212) along with the fees for the resources used by the VM and how the fees were calculated. Specifically, the resource usage report can include, but is not limited to, resource usage data per unit of time, excess resource usage per resource used per unit of time, any rolled over resources, the total runtime of the VM, and any fixed fees associated with the running of the VM. For example, the VM resource computing device 218 can be implemented to store the resource usage report in the resource utilization database 220 in association with an identifier of the user that requested the running of the VM. The VM resource computing device 218 can also be implemented to provide the resource usage report (e.g., as a file) to the computing device 206 for display to the user on the display 206a via the internal network 208, the cluster manager 204 and the external network 210.

In general, the user can review the resource usage report to better understand the running of their application on the VM. For example, the user can decide to modify their application in order to better utilize resources during the runtime of the VM in order to reduce any excess resource usage fees and to better utilize all of the prepaid base usage resources.

In some implementations, the user of the system 200 is provided with a resource usage report after the VM has terminated. In some cases, the resource usage report can be provided immediately after the termination of the VM. In some cases, the user can be provided with one or more resource usage reports on a regular predetermined basis (e.g., once a day, once a week, etc.) or when requested by the user. In some implementations, a resource usage report can be provided to the user after each unit of time has passed (e.g., after each 5-minute unit of time). In this case, the resource usage report can indicate the resources used up to a point in time along with the current cost of the resources. These resource usage reports may be provided until the VM is terminated. Upon termination of the VM, the system 200 can be implemented to then provide a final resource usage report to the user.

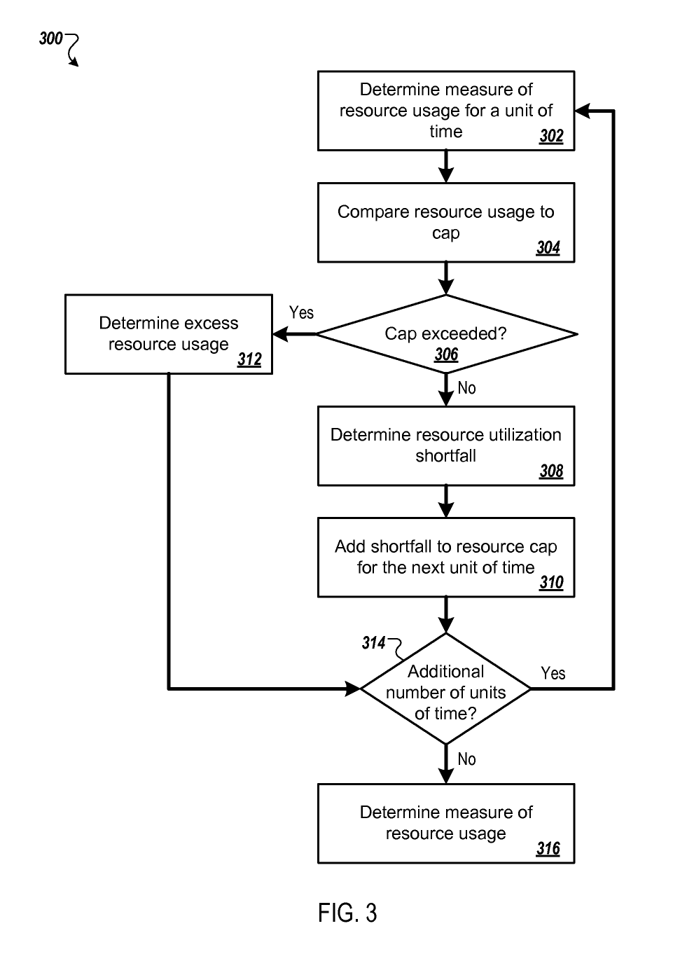

FIG. 3 is a flow diagram illustrating an example process 300 for determining a measure of resource usage by a virtual machine. For example, the process 300 may be performed by the system 200 shown in FIG. 2.

The process 300 begins by determining a measure of resource usage for a particular unit of time (302). For example, the measure can be the number of disk I/O accesses performed during the particular unit of time by a VM during the runtime of the VM (between the startup and termination of the VM). The unit of time can be a particular unit of time in a sequence of contiguous units of time. The process 300 compares the measured resource usage for the particular unit of time to the number of utilized resources characterized by the general resource cap for the particular resource for the unit of time (304). For example, the number of disk I/O accesses performed during the particular unit of time is compared to the number of utilized resources characterized by the general resource cap for disk I/O accesses for the unit of time.

If the general resource cap for the resource for the unit of time is not exceeded (306), a resource utilization shortfall is determined (308). The resource utilization shortfall is the difference between the measured resource usage for the particular unit of time and the number of utilized resources characterized by the general resource cap for the particular utilized resource for the unit of time. The resource utilization shortfall is added to the number of utilized resources characterized by the general resource cap for the next unit of time in the sequence of contiguous units of time (310). This results in an adjusted resource cap for the next unit of time that is equal to the general resource cap plus the resource utilization shortfall. In some implementations, the entire resource utilization shortfall is added to the number of utilized resources characterized by the general resource cap for the next unit of time. In some implementations, only a portion of the resource utilization shortfall is added to the number of utilized resources characterized by the general resource cap for the next unit of time. In some cases, the portion of the resource utilization shortfall that may be added to the number of utilized resources characterized by general resource cap for the next unit of time may also be capped. As described in the example of FIG. 2, a rollover resource cap is a fixed amount of resource utilization shortfall that may not be exceeded for rollover. For example, the number of utilized resources characterized by rollover resource cap may be a predetermined fixed number of resource utilizations or a percentage of the general resource cap of resource utilizations.

If the number of utilized resources characterized by the general resource cap for the resource for the unit of time is exceeded (306), excess resource usage is determined (312). The excess resource usage can be used to determine if any additional fees will be charged to a user for the use of the excess resources during the particular unit of time. If there are additional units of time in the sequence of contiguous units of time where a measure of resource usage has not yet been determined (314), the process 300 proceeds to step 302 and determines a measure of resource usage for the next unit of time in the sequence of contiguous units of time.

If there are no additional units of time in the sequence of contiguous units of time where a measure of resource usage has not yet been determined (314), the process 300 determines a total measure of resource usage for the particular resource by the VM from the startup to the termination of the VM (the entire runtime of the VM). In addition, the process 300 can be performed for each resource used by a VM. For example, the process 300 can determine a measure of network accesses and a measure of IP addresses used.

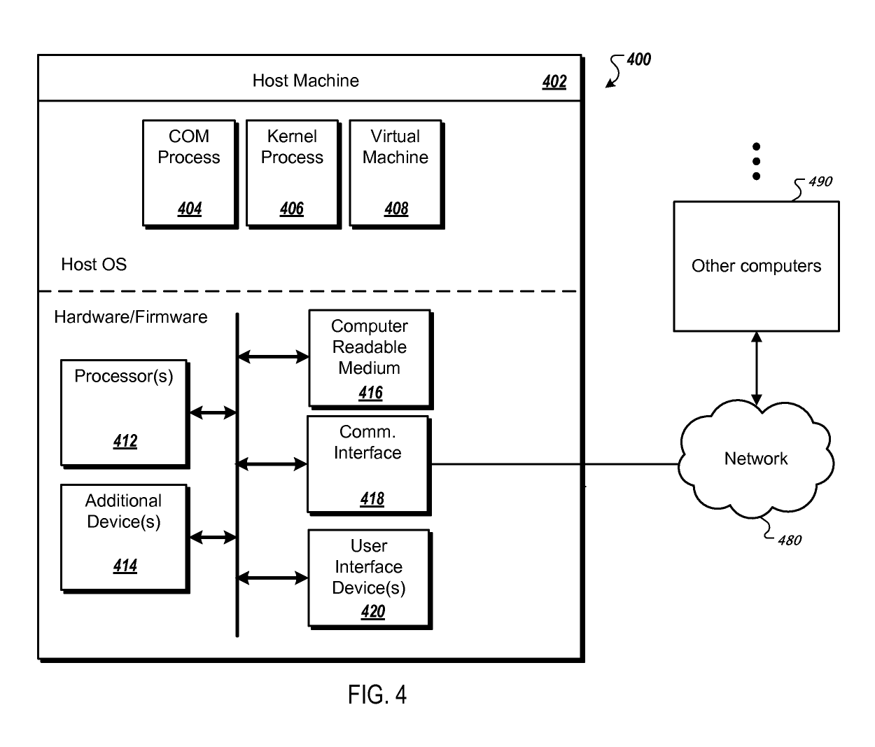

FIG. 4 is a schematic diagram of an example host machine. The host machine 400 generally consists of a data processing apparatus 402. The data processing apparatus 402 can optionally communicate with one or more other computers 490 through a network 480. While only one data processing apparatus 402 is shown in FIG. 4, multiple data processing apparatus can be used in one or more locations. The data processing apparatus 402 includes various modules, e.g. executable software programs. One of the modules is the kernel 406 of a host operating system (e.g., host operating system 106). A communication process module 404 (e.g., communication process 106c ) is configured to establish VNPs, encapsulate packets and to de-encapsulate packets. A virtual machine module 408 (e.g., virtual machine 110) includes virtual hardware (e.g., virtual hardware 110a ), a guest operating system (e.g., guest operating system110b ), and guest applications (guest applications 110c ). Although several software modules are illustrated, there may be fewer or more software modules. Moreover, the software modules can be distributed on one or more data processing apparatus connected by one or more networks or other suitable communication mediums.

The data processing apparatus 402 also includes hardware or firmware devices including one or more processors 412, one or more additional devices 414, a computer readable medium 416, a communication interface 418, and optionally one or more user interface devices 420. Each processor 412 is capable of processing instructions for execution within the data processing apparatus 402. In some implementations, the processor 412 is a single or multi-threaded processor. Each processor 412 is capable of processing instructions stored on the computer readable medium 416 or on a storage device such as one of the additional devices 414. The data processing apparatus 402 uses its communication interface 418 to communicate with one or more computers 490, for example, over a network 480. Examples of user interface devices 420 include a display, a camera, a speaker, a microphone, a tactile feedback device, a keyboard, and a mouse. The data processing apparatus 402 can store instructions that implement operations associated with the modules described above, for example, on the computer readable medium 416 or one or more additional devices 414, for example, one or more of a floppy disk device, a hard disk device, an optical disk device, or a tape device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A non-transitory computer storage medium encoded with a computer program, the program comprising instructions that when executed by one or more computers cause the one or more computers to perform operations comprising:
managing performance of a virtual machine system at a desired level of performance using a respective resource utilization cap for each computing resource used by each virtual machine hosted by the virtual machine system and a respective hard cap for each computing resource used by each virtual machine hosted by the virtual machine system, wherein the respective hard cap for each computing resource is determined based on the desired level of performance, the managing comprising:
for each virtual machine hosted by the virtual machine system:
limiting resource usage of each computing resource used by the virtual machine to an amount that is less than or equal to the respective hard cap for the computing resource and the virtual machine;
allowing the virtual machine to use an amount of each computing resource that (i) exceeds the respective resource utilization cap for the computing resource and the virtual machine and (ii) is less than or equal to the respective hard cap for the computing resource and the virtual machine;
determining a measure of resource usage by the virtual machine, comprising:
for each unit of time in the sequence of contiguous units of time beginning from the completion of a prestart time period and ending with a unit of time within which a termination of the virtual machine occurs, wherein the prestart time period is a plurality of units of time from a startup of the virtual machine to the completion of the prestart time period, and for each of one or more monitored computing resources used by the virtual machine:
comparing actual resource utilization of the computing resource by the virtual machine during the unit of time with the respective resource utilization cap for the computing resource for the unit of time; and
for each unit of time that the actual resource utilization exceeds the respective resource utilization cap for the computing resource, determining an amount of excess resource utilization for the computing resource for the unit of time, wherein for at least one of the units of time the actual resource utilization exceeds the resource utilization cap;
determining the measure of resource usage by the virtual machine based on the number of units of time, the respective resource utilization cap for each computing resource, and the amount of each excess resource utilization for each computing resource;
determining an excess resource utilization fee based on the amount of each excess resource utilization for each resource; and
determining a total fee based on (i) a prestart fee that is associated with the prestart time period, wherein an amount of the prestart fee is not based on an amount of resource utilization by the virtual machine during the prestart time, and (ii) the excess resource utilization fee.

2. The medium of claim 1, wherein the operations further comprise:
determining a number of contiguous units of time in the sequence of contiguous units of time;
determining a resource securing fee, the resource securing fee being a result of multiplying the determined number of contiguous units of time with a fee per unit of time; and
identifying a result of adding (i) the resource securing fee, and (ii) the excess resource utilization fee.

3. The medium of claim 2, wherein determining the resource securing fee further comprises determining the fee per unit of time by accessing a resource usage fee table.

4. The medium of claim 1, wherein the operations further comprise:
determining a number of contiguous units of time in the sequence of contiguous units of time;
determining a resource securing fee, the resource securing fee being a result of multiplying the determined number of contiguous units of time with a fee per unit of time; and
identifying a result of adding (i) a minimum resource securing fee associated with securing computing resources in the virtual machine system, (ii) the resource securing fee, and (iii) the excess resource utilization fee.

5. The medium of claim 1, wherein the one or more monitored computing resources comprise disk I/O accesses, network utilization, memory usage and network address usage.

6. The medium of claim 1, wherein the operations further comprise:
identifying a first detection of a heartbeat as indicative of the startup of the virtual machine;
identifying a detection of an absence of the heartbeat as indicative of the termination of the virtual machine; and
determining the measure of resource usage by the virtual machine for a time interval defined by the first detection of the heartbeat and the detection of the absence of the heartbeat.

7. The medium of claim 1, wherein upon the actual resource utilization being less than the resource utilization cap for the computing resource, the operations further comprise:
(i) determining a resource utilization shortfall for the computing resource for the unit of time, and
(ii) adding at least a portion of the resource utilization shortfall to a resource utilization cap for the computing resource for the subsequent unit of time.

8. The medium of claim 7, wherein the portion of the resource utilization shortfall for the computing resource for the unit of time is less than or equal to a resource utilization shortfall cap.

9. A computer-implemented method comprising:
managing performance of a virtual machine system at a desired level of performance using a respective resource utilization cap for each computing resource used by each virtual machine hosted by the virtual machine system and a respective hard cap for each computing resource used by each virtual machine hosted by the virtual machine system, wherein the respective hard cap for each computing resource is determined based on the desired level of performance, the managing comprising:
for each virtual machine hosted by the virtual machine system:
limiting resource usage of each computing resource used by the virtual machine to an amount that is less than or equal to the respective hard cap for the computing resource and the virtual machine;
allowing the virtual machine to use an amount of each computing resource that (i) exceeds the respective resource utilization cap for the computing resource and the virtual machine and (ii) is less than or equal to the respective hard cap for the computing resource and the virtual machine;
determining, by a processor, a measure of resource usage by the virtual machine, comprising:
for each unit of time in the sequence of contiguous units of time beginning from the completion of a prestart time period and ending with a unit of time within which a termination of the virtual machine occurs, wherein the prestart time period is a plurality of units of time from a startup of the virtual machine to the completion of the prestart time period, and for each of one or more monitored computing resources used by the virtual machine:
comparing actual resource utilization of the computing resource by the virtual machine during the unit of time with the respective resource utilization cap for the computing resource for the unit of time; and
for each unit of time that the actual resource utilization exceeds the respective resource utilization cap for the computing resource, determining an amount of excess resource utilization for the computing resource for the unit of time, wherein for at least one of the units of time the actual resource utilization exceeds the resource utilization cap;
determining, by the processor, the measure of resource usage by the virtual machine based on the number of units of time, the respective resource utilization cap for each computing resource, and the amount of each excess resource utilization for each computing resource;
determining, by the processor, an excess resource utilization fee based on the amount of each excess resource utilization for each resource; and
determining a total fee based on (i) a prestart fee that is associated with the prestart time period, wherein an amount of the prestart fee is not based on an amount of resource utilization by the virtual machine during the prestart time, and (ii) the excess resource utilization fee.

10. The method of claim 9, further comprising:
determining, by the processor, a number of contiguous units of time in the sequence of contiguous units of time;
determining, by the processor, a resource securing fee, the resource securing fee being a result of multiplying the determined number of contiguous units of time with a fee per unit of time; and
identifying, by the processor, a result of adding (i) the resource securing fee, and (ii) the excess resource utilization fee.

11. The method of claim 10, wherein determining the resource securing fee further comprises determining the fee per unit of time by accessing a resource usage fee table.

12. The method of claim 9, further comprising:
determining, by the processor, a number of contiguous units of time in the sequence of contiguous units of time;
determining, by the processor, a resource securing fee, the resource securing fee being a result of multiplying the determined number of contiguous units of time with a fee per unit of time; and
identifying, by the processor, a result of adding (i) a minimum resource securing fee associated with securing computing resources in the virtual machine system, (ii) the resource securing fee, and (iii) the excess resource utilization fee.

13. The method of claim 9, wherein the one or more monitored computing resources comprise disk I/O accesses, network utilization, memory usage and network address usage.

14. The method of claim 9, further comprising:
identifying, by the processor, a first detection of a heartbeat as indicative of the startup of the virtual machine;
identifying, by the processor, a detection of an absence of the heartbeat as indicative of the termination of the virtual machine; and
determining, by the processor, the measure of resource usage by the virtual machine for a time interval defined by the first detection of the heartbeat and the detection of the absence of the heartbeat.

15. The method of claim 9, wherein upon the actual resource utilization being less than the resource utilization cap, the operations further comprise:
(i) determining, by the processor, a resource utilization shortfall for the computing resource for the unit of time, and
(ii) adding, by the processor, at least a portion of the resource utilization shortfall to a resource utilization cap for the computing resource for the subsequent unit of time.

16. The method of claim 15, wherein the portion of the resource utilization shortfall for the computing resource for the unit of time is less than or equal to a resource utilization shortfall cap.

17. A system comprising:
one or more computers; and
a computer-readable storage device having stored thereon instructions that, when executed by the one or more computers, cause the one or more computers to perform operations comprising:
managing performance of a virtual machine system at a desired level of performance using a respective resource utilization cap for each computing resource used by each virtual machine hosted by the virtual machine system and a respective hard cap for each computing resource used by each virtual machine hosted by the virtual machine system, wherein the respective hard cap for each computing resource is determined based on the desired level of performance, the managing comprising:
for each virtual machine hosted by the virtual machine system:
limiting resource usage of each computing resource used by the virtual machine to an amount that is less than or equal to the respective hard cap for the computing resource and the virtual machine;
allowing the virtual machine to use an amount of each computing resource that (i) exceeds the respective resource utilization cap for the computing resource and the virtual machine and (ii) is less than or equal to the respective hard cap for the computing resource and the virtual machine;
determining a measure of resource usage by the virtual machine, comprising:
for each unit of time in the sequence of contiguous units of time beginning from the completion of a prestart time period and ending with a unit of time within which a termination of the virtual machine occurs, wherein the prestart time period is a plurality of units of time from a startup of the virtual machine to the completion of the prestart time period, and for each of one or more monitored computing resources used by the virtual machine:
comparing actual resource utilization of the computing resource by the virtual machine during the unit of time with the respective resource utilization cap for the computing resource for the unit of time; and
for each unit of time that the actual resource utilization exceeds the respective resource utilization cap for the computing resource, determining an amount of excess resource utilization for the computing resource for the unit of time, wherein for at least one of the units of time the actual resource utilization exceeds the resource utilization cap;
determining the measure of resource usage by the virtual machine based on the number of units of time, the respective resource utilization cap for each computing resource, and the amount of each excess resource utilization for each computing resource;
determining an excess resource utilization fee based on the amount of each excess resource utilization for each resource; and
determining a total fee based on (i) a prestart fee that is associated with the prestart time period, wherein an amount of the prestart fee is not based on an amount of resource utilization by the virtual machine during the prestart time, and (ii) the excess resource utilization fee.

18. The system of claim 17, wherein the operations further comprise:
determining a number of contiguous units of time in the sequence of contiguous units of time;
determining a resource securing fee, the resource securing fee being a result of multiplying the determined number of contiguous units of time with a fee per unit of time; and
identifying a result of adding (i) the resource securing fee, and (ii) the excess resource utilization fee.

19. The system of claim 18, wherein determining the resource securing fee further comprises determining the fee per unit of time by accessing a resource usage fee table.

20. The system of claim 17, wherein the operations further comprise:
determining a number of contiguous units of time in the sequence of contiguous units of time;
determining a resource securing fee, the resource securing fee being a result of multiplying the determined number of contiguous units of time with a fee per unit of time; and
identifying a result of adding (i) a minimum resource securing fee associated with securing computing resources in the virtual machine system, (ii) the resource securing fee, and (iii) the excess resource utilization fee.

21. The system of claim 17, wherein the one or more monitored computing resources comprise disk I/O accesses, network utilization, memory usage and network address usage.

22. The system of claim 17, wherein the operations further comprise:
identifying a first detection of a heartbeat as indicative of the startup of the virtual machine;
identifying a detection of an absence of the heartbeat as indicative of the termination of the virtual machine; and
determining the measure of resource usage by the virtual machine for a time interval defined by the first detection of the heartbeat and the detection of the absence of the heartbeat.

23. The system of claim 17, wherein upon the actual resource utilization being less than the resource utilization cap, the operations further comprise:
(i) determining a resource utilization shortfall for the computing resource for the unit of time, and
(ii) adding at least a portion of the resource utilization shortfall to a resource utilization cap for the computing resource for the subsequent unit of time.

24. (canceled)

25. The system of claim 17, wherein the respective hard cap for at least one computing resource used by at least one virtual machine is less than a total amount of the computing resource available in the virtual machine system.
